(19) United States
(12) Patent Application Publication
(10) Pub. No.: US 2012/0320215 A1
(43) Pub. Date: Dec. 20, 2012

(54) Method of Creating a Room Occupancy System by Executing Computer-Executable Instructions Stored on a Non-Transitory Computer-Readable Medium

(76) Inventor: David Vincent MADDI, Fort Myers, FL (US)

(21) Appl. No.: 13/525,178

(22) Filed: Jun. 15, 2012

Related U.S. Application Data
(60) Provisional application No. 61/497,220, filed on Jun. 15, 2011.

(51) Int. Cl. H04N 5/30; H04N 7/18

(52) U.S. Cl. 348/155; 348/E05.085; 348/E07.085

(57) ABSTRACT

The present invention is a room occupancy detection system that uses software methods to determine if an individual is currently within a room, strictly without using any human interaction. A thermal imaging system scans the room for thermal signatures that match an occupant thermal signature. A motion detection system detects movement within the room in order to supplement the thermal imaging system. A control system interprets data received by the thermal imaging system and the motion detection system in order to accurately determine if the room is currently occupied. The present invention can also determine the number of occupants within a room. All data and determinations from the control system are saved within a storage database. An individual can retrieve any information, such as the occupancy status and occupancy number from a communication device. The present invention can also be implemented into a building with more than one room.

The current application claims a priority to the U.S. Provisional Patent application Ser. No. 61/497,220 filed on Jun. 15, 2011.

### FIELD OF THE INVENTION

The present invention relates generally to a software controlled room occupancy system. More specifically, the objective is to use thermal imaging cameras 1 and motion detection sensors in order to determine if a room is occupied.

### BACKGROUND OF THE INVENTION

Typically, housekeepers and maids need to knock and open the doors to a room to test for room occupancy in almost all types of hospitality environments. Tenants and hotel managers may also desire to know if a room is occupied so that the room can be investigated or accessed. The present invention solves this problem by placing a set of small non-invasive infrared/thermal imaging cameras, and motion detection sensors inside the room to constantly test for occupancy. The present invention utilizes a combination of infrared/thermal imaging cameras, motion sensors, and processing software to determine if a room is currently occupied or not. Housekeepers can access the up to the second data via a handheld communication device (or any device capable of such a connection) that accesses occupancy information about a particular room from a storage database. A user can then immediately know if the room is currently occupied or unoccupied. Although the present invention uses sensors that currently exist in some other products to detect motion and infrared/thermal imaging, it will use these tools in a new way to determine room occupancy that is completely noninvasive. The software monitors occupancy, which allows the present invention to give information unattainable by any product available today.

The present invention can also be used as a prison cell monitor, constantly monitoring while they are within a locked cell. Any type of escape or miscount would be detected by the present invention and result in an immediate desired response to the prison.

Not only hotels and prisons can implement the present invention, but large-scale buildings could use the present invention as a very intuitive safety feature. Whether fire, flood, or natural disaster jeopardizes the safety of the individuals within the building, the power of knowing how many people you need to save or evacuate and exactly what floor and room those people are in could save uncounted lives of both the occupants and the rescue workers. A fire chief could enter a disaster situation with the ability of knowing exactly how many individuals need to be rescued, and exactly where those individuals are located, nearly instantaneously.

### BRIEF DESCRIPTION OF THE DRAWINGS

FIG. 1 is a flow chart illustrating the overall process that is followed by the present invention.

FIG. 2 is a flow chart illustrating the secondary process of finding an occupant thermal signature.

FIG. 3 is a flow chart illustrating the secondary process of determining occupancy status.

FIG. 4 is a flow chart illustrating another secondary process of determining occupancy status.

FIG. 5 is flow chart illustrating another secondary process of determining occupancy status.

FIG. 6 is a flow chart illustrating the secondary process of computing occupancy number.

FIG. 7 is a flow chart illustrating the secondary process of displaying the occupancy status and occupancy number through the communication device.

FIG. 8 is a flow chart further illustrating the secondary process of computing occupancy status and occupancy number through the communication device.

FIG. 9 is a schematic view of the network connections of the present invention.

### DETAIL DESCRIPTIONS OF THE INVENTION

All illustrations of the drawings are for the purpose of describing selected versions of the present invention and are not intended to limit the scope of the present invention.

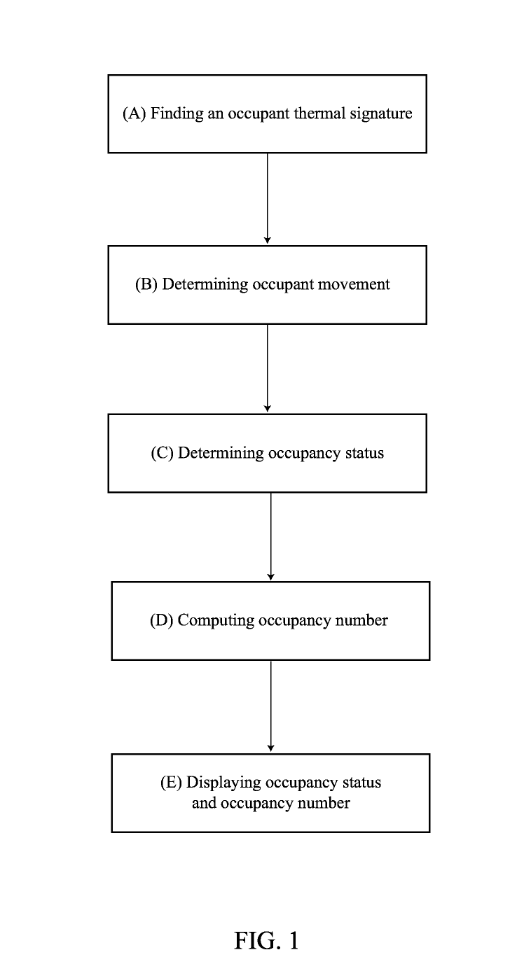

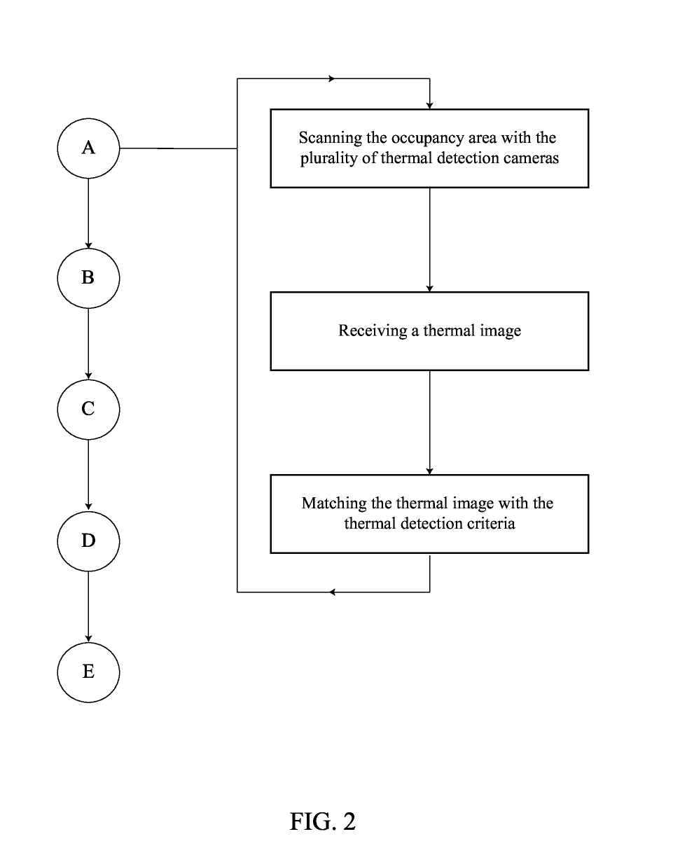

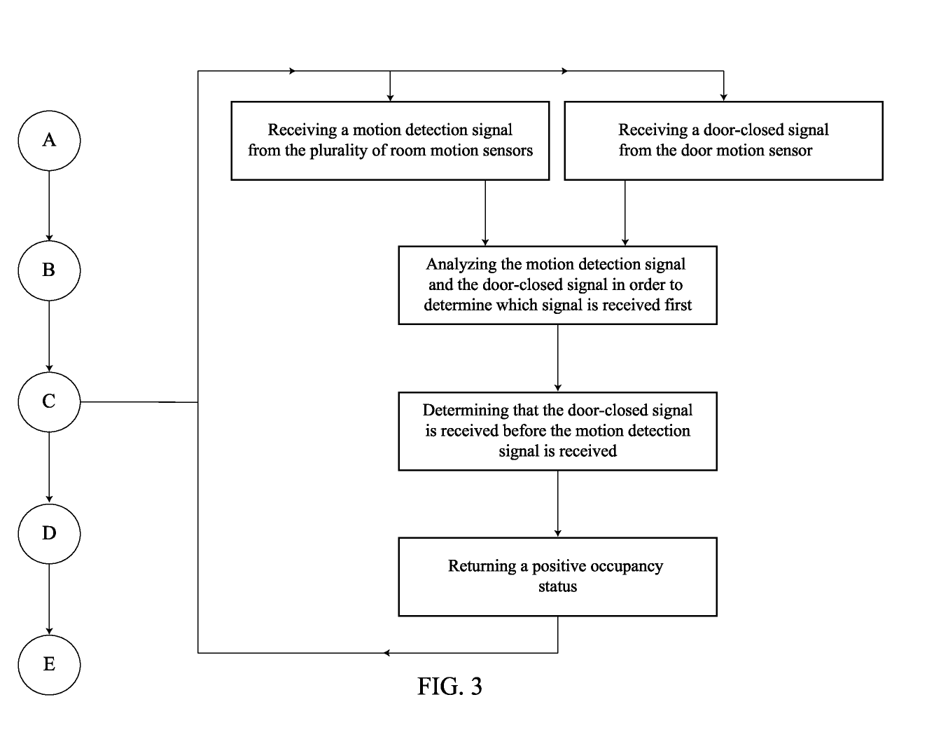

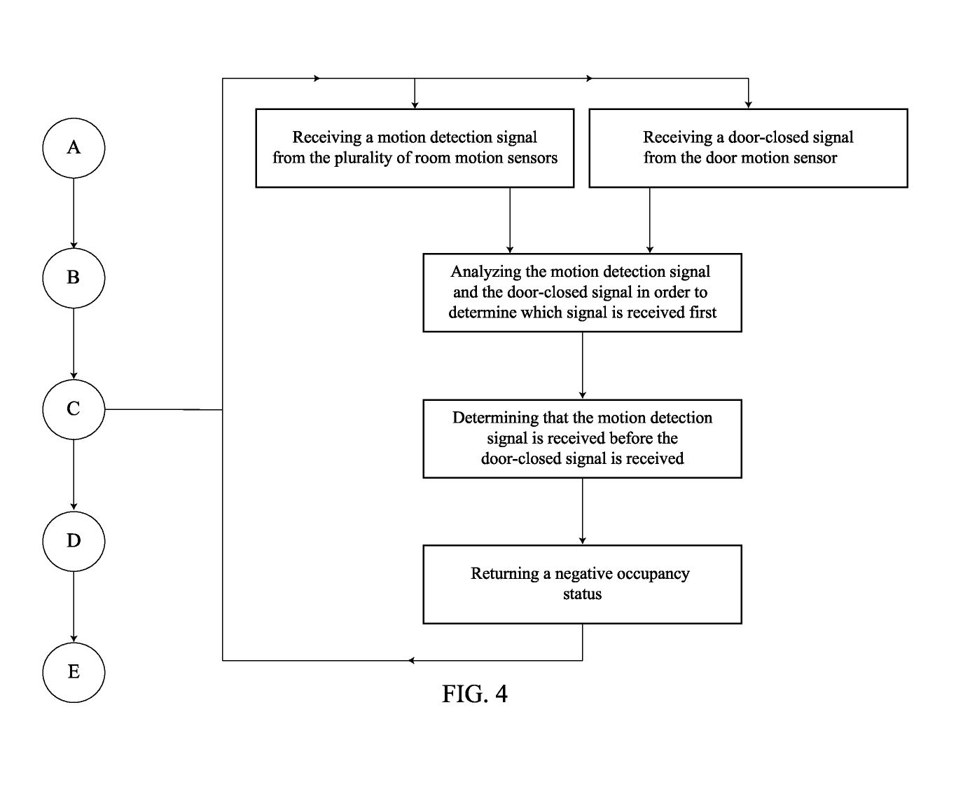

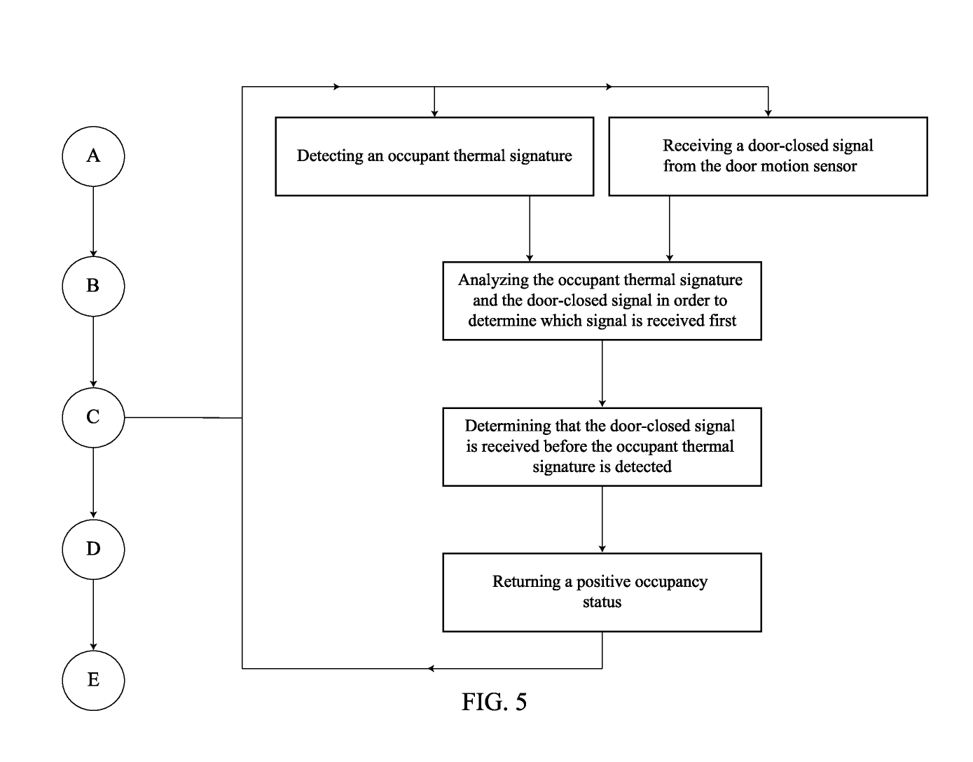

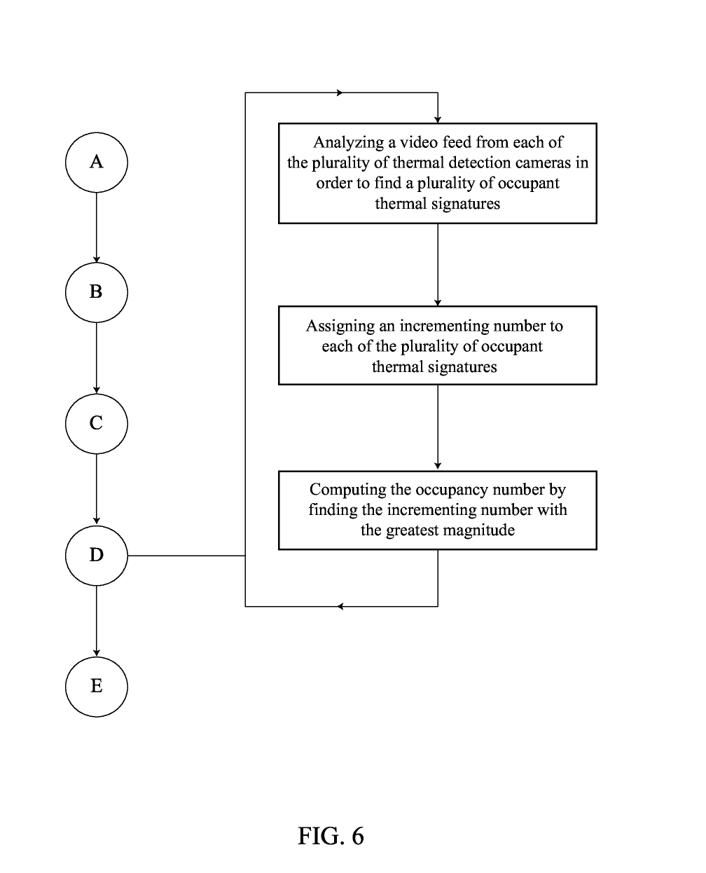

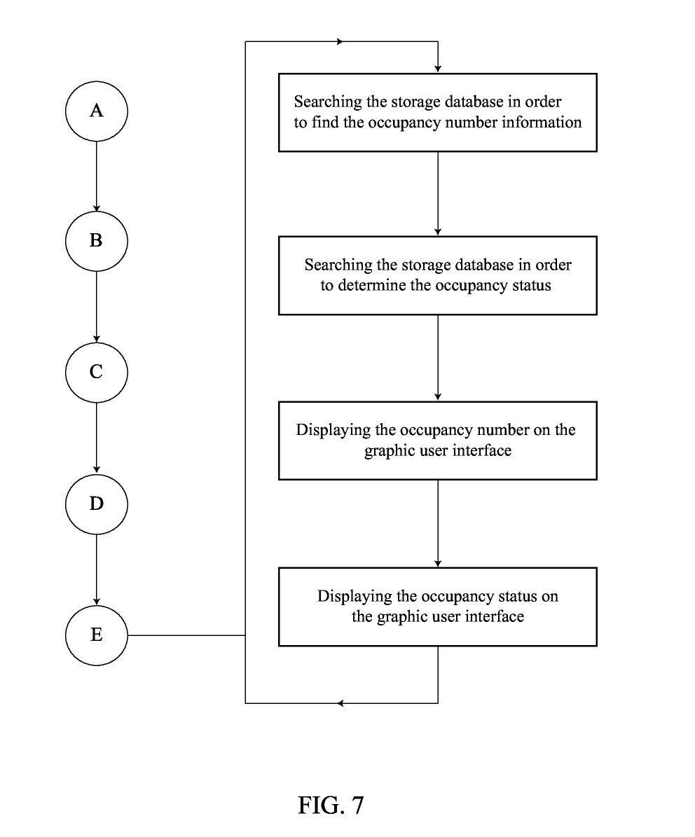

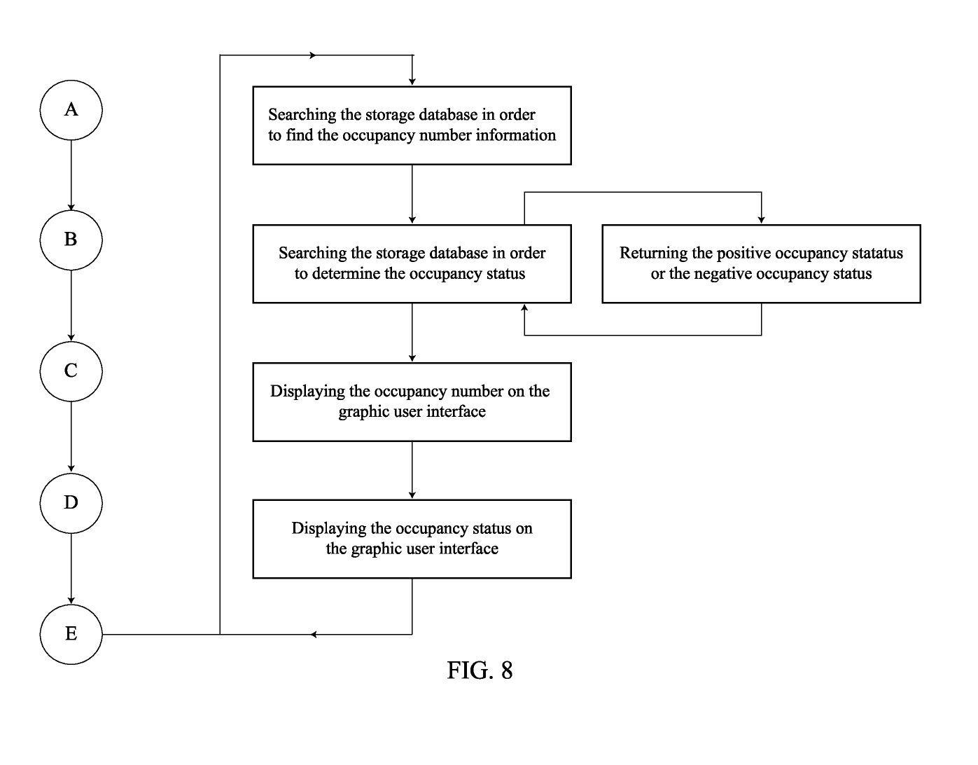

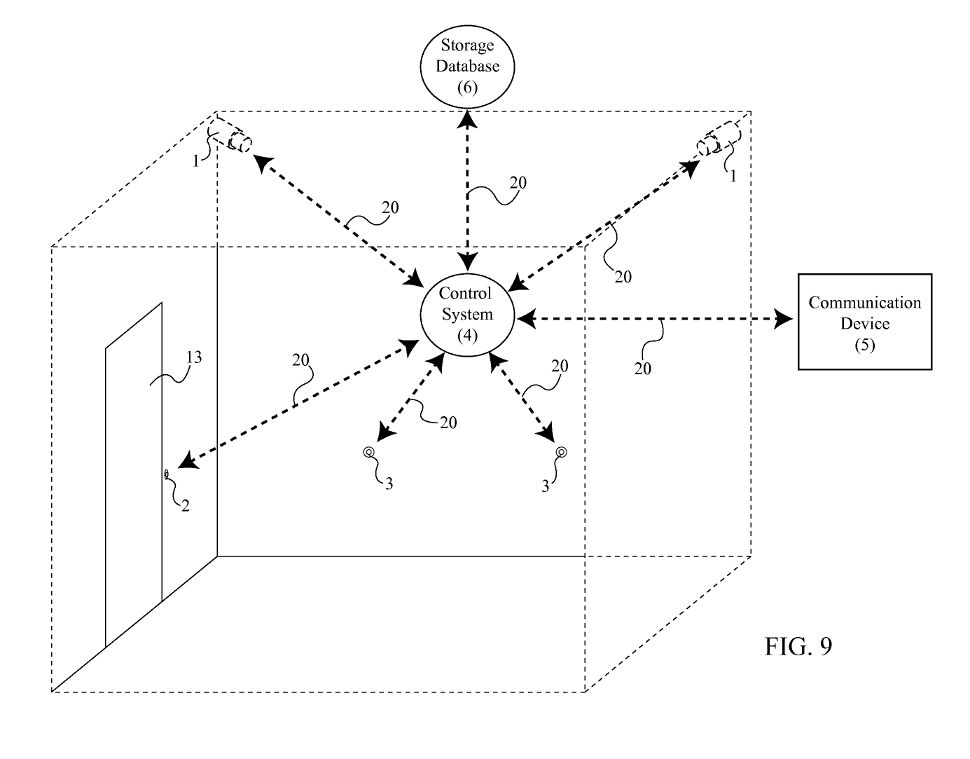

The present invention is a software controlled room occupancy detection system that can detect if a room is empty or occupied. The present invention achieves this functionality using a control system 4, a communication device 5, a thermal imaging system 7, and a motion detection system 8. The overall process and the secondary processes are delineated in FIG. 1-FIG. 8. A schematic of connections between the components within the present invention is shown in FIG. 9. The thermal imaging system 7 and the motion detection system 8 both relay information about the current state of the room to the control system 4. Ultimately, the control system 4 processes and analyzes information from the thermal imaging system 7 and the motion detection system 8 in order to determine if the room is currently occupied. The control system 4 sends updated information about the current state of the room to the storage database 6. A user can discover if a room is currently occupied by operating the communication device 5. The communication device 5 retrieves stored information about the occupancy of a room by accessing the storage database 6. The occupancy of multiple rooms can be determined by implementing the present invention into each room of a building. Also, the number of occupants within a room can be determined by the present invention.

The thermal imaging system 7 comprises a plurality of thermal detection cameras 1. These thermal detection cameras 1 continually scan the innards of a room to detect an occupant's thermal signature. Typically, a room comprises a floor, a ceiling, an occupancy area 9, a plurality of inner walls 11, and a door 13. The occupancy area 9 should be delineated by the ceiling, the floor, the plurality of inner walls 11, wherein the plurality of inner walls 11 comprises an entrance wall 12. Essentially, the occupancy area 9 is the space within the room that an occupant would reside. The entrance wall 12 is traversed by an entrance opening in which the door 13 is housed within. The motion detection system 8 comprises a door motion sensor 2 and a plurality of room motion sensors 3. The door motion sensor 2 detects whether the door 13 is currently open or closed, while the plurality of room motion sensors 3 detects movement within the occupancy area 9. The present invention can be integrated into a room of any size and shape for as long as an occupancy area 9 can be defined by the thermal imaging system 7 and motion detection system 8. A schematic of the present invention integrated within a room is shown in FIG. 9. An occupant should first enter the room through the entrance opening, and then close the door 13. The control system 4 should recognize that the door 13 has been closed. The control system 4 comprises signal processing software that can interpret and analyze information being received by the thermal imaging system 7 and the motion detection system 8. This information should be sent to the signal processing software. The thermal imaging system 7, the motion detection system 8, and the communication device 5 are communicatively connected to the control system 4 through a network connection 20. This network connection 20 could be made using electrical signals, radiofrequency signals, or any similar existing technology. However, the present invention should not be limited by such information transfer methods. Either a positive occupancy status or a negative occupancy status is determined by the signal processing software in which the storage database 6 is then updated with this determination. A positive occupancy status means that the room is currently occupied; a negative occupancy status means that the room is currently unoccupied. The communication device 5 displays either the positive occupancy status or the negative occupancy status of the room being monitored. The preferred embodiment of the communication device 5 is a portable handheld electronic device such as a tablet. As aforementioned, the present invention can be applied to a building with more than one room such as a hotel. In this instance, hotel staff could simply access the occupancy of each room within the hotel by using the communication device 5.

In the preferred embodiment of the present invention, the thermal detection cameras 1 should be infrared cameras. These infrared cameras should use optical lenses and infrared-detector elements to capture and focus infrared light, and then convert the infrared light into electrical signals. The signal processing software should then compatibly receive these electrical signals. The focused infrared light should be scanned by a phased array of infrared-detector elements so that a detailed temperature pattern can be created. This detailed temperature pattern is known as a thermogram. The scope of the present invention is to analyze this thermogram to determine if a matching thermal signature is found residing within field of view of the thermal detection camera. Essentially, the thermogram is a thermal image. The thermal imaging system 7 should render the thermogram into electrical impulse signals to be sent to the signal processing software. The signal processing software can then interpret and analyze the electrical impulse signals. A human thermal signature can be determined from the thermogram because the human body maintains a constant body temperature, which is distinguishable from a thermogram. Human body temperature is usually dissimilar to the temperature of the room and also to most objects within the room. In order to ensure that the thermal detection cameras 1 are truly capturing a human thermal signature, thermal detection criteria are provided. Specific variables are defined by the control system 4 by using the thermal detection criteria, such as the actual temperature, the height, width, and/or length. Matching human signature patterns can be determined from these parameters; although, additional parameters could also be included. Each thermal detection camera is strategically positioned within the room to ensure that the occupancy area 9 is completely monitored. The entire occupancy area 9 should be visible to the plurality of thermal detection cameras 1.

The thermal imaging system 7 could possibly use low definition infrared blob technology so as not to infringe on the occupants privacy, yet still attain an accurate occupancy result. In other words, the objects within the room being tested do not need to be as highly defined as high quality video feeds to obtain the results. A lower definition may be used. Since the determination of room occupancy is completely performed through the control system 4, the privacy of the occupant's would be maintained. Therefore, video recordings from the thermal imaging system 7 do not need to be saved as a core need of the control system 4 to determine room occupancy. However, the present invention should have this capability and be able to save the video feeds from the thermal imaging system 7 within the storage database 6 for security and surveillance reasons, providing the present invention with an additional functionality.

The motion detection system 8 supplements the thermal imaging system 7 and the control system 4 in the determination of a positive occupancy status or negative occupancy status. Since it is possible that the thermal imaging system 7 may render a thermal signature that closely represents a human thermal signature, yet the thermal signature is misrepresented, the motion detection system 8 is needed. For example, a heating system may automatically power on while a room is unoccupied and the thermal imaging system 7 may pick up the thermal signature of a heat vent. The control system 4 might then determine that the heat vent's thermal signature matches the thermal detection criteria. Of course, this is not truly a human's thermal signature. The motion detection system 8 alerts the control system 4 that there is also motion within the occupancy area 9 or if the door 13 is closed. If the door motion sensor 2 sends a door-closed signal and a thermal signature matching the thermal detection criteria is rendered by the thermal imaging system 7, then the control system 4 should return a positive occupancy status. If no motion has occurred since the door motion sensor 2 has sent a door-closed signal and the thermal imaging system 7 also renders a thermal signature matching the thermal detection criteria, then the control system 4 should return a negative occupancy status. Clearly, this dynamic provides a much more authentic determination of room occupancy. Preferably, the door motion sensor 2 is positioned between door and the entrance wall 12 to detect if the door 13 is currently opened or closed. However, the door motion sensor 2 could be positioned in any location near the door 13, for as long as the door motion sensor 2 is triggered only after the door 13 has been closed. Similar to the plurality of thermal detection cameras 1, each of the plurality of room motion sensors 3 is strategically positioned within the occupancy area 9. Any motion or disturbance within the occupancy area 9 should be detected by the plurality of room motion sensors 3. The door motion sensor 2 and the plurality of room motion sensors 3 should send a motion detection signal to the signal processing software once motion is detected.

In order to account for natural vibrations and unrelated accidental forces from outside of the room that may trigger the room motion sensors 3, motion detection criteria can be provided. Essentially, motion detection criteria should filter out these vibrations and forces so that actual movement within the room triggers the room motion sensors 3. For example, vibrations greater than a set magnitude or motion greater than a specified degree that would be calibrated to match a human's movement should only trigger the room motion sensors 3. The control system 4 should have access to motion detection criteria so that these disturbances do not produce a “false” positive occupancy status.

The control system 4 can either directly analyze the motion detection signals from the motion detection system 8 and the thermal imaging system 7 to instantaneously return a positive occupancy status or negative occupancy status, or the control system 4 can execute a series of tests after the motion detection signals are received in order to determine a positive occupancy status or a negative occupancy status. The thermal image from the thermal imaging system 7 and the motion detection system 8 are received by signal processing software. The order that an occupant thermal signal is detected and a motioned detection signal is received by the signal processing software is not integral to the present invention. The signal processing software can determine if the room motion sensors 3 have detected motion while the door 13 is closed, and then check if the object moving within the room, which has triggered the motion detection system 8, is also characterized by the thermal detection criteria, or vice versa. In either instance, a positive occupancy status would be returned by the signal processing software if an occupant were within the occupancy area 9. In terms of the motion detection system 8, the signal processing software analyzes the timing of the door 13 being closed. If the door 13 is currently closed and the room motion sensors 3 detect motion, then it is likely, yet unconfirmed, that the room is occupied. The signal processing software must receive a door-closed signal prior to receiving an occupant's movement signal if a positive occupancy status is to be returned. The timing of these events can either me determined directly from the motion detection system 8 or the information can be later retrieved the storage database 6. Furthermore, the present invention should not be limited by either situation for as long as the control system 4 can determine that an occupant's movement has been received after the door 13 has been closed.

The present invention can determine the number of occupants within an occupancy area 9. This is primarily performed through the thermal imaging system 7. The control system 4 should be able to integrate software that can decipher if multiple occupants are found within a single thermal detection camera. This should allow the control system 4 to analyze the video feed from each of the thermal detection cameras 1 in order to find a plurality of occupant thermal signatures. The video feed is essentially a series of thermal images from a thermal detection camera. It is possible that adjacently positioned thermal detection cameras 1 may render an unequivocal number of occupants. Therefore, the control system 4 would count the number of occupant's within each respective thermal detection camera and assign an incremental number to each occupant; the first occupant would be assigned the number 1, the second would be assigned the number 2, and so on. The numbers of occupant thermal signatures determined from each video feed is compared in order to find the greatest number of occupant thermal signatures that are detected from the plurality of thermal detection cameras. The greatest number of occupant thermal signatures relates to the occupancy number. A positive occupancy status should also be determined by the control system 4 prior to determining the occupancy number.

Occupancy status and occupancy number, if applicable, should be displayed on a graphic user interface through the communication device 5. The communication device 5 should be prompted by the control system 4 to retrieve information about the occupancy of the room. A user would then select the room that the occupancy is desired to be known. The communication device 5 should then access the storage database 6 and retrieve the desired occupancy information. Accessing the storage database 6 will give an up to the second detail of room occupancy. If multiple rooms are being monitored through the present invention, the user should be able to retrieve occupancy information about which rooms are currently occupied, and which rooms are currently empty. This will allow housekeepers or maids, as examples, to obtain room occupancy information without knocking and waking into the room, disturbing the occupants. Also, the communication device 5 could allow firefighters and rescue personnel to instantly obtain an accurate account of the facility as a whole, providing a distinct advantage in saving lives. This is an advantage because resources could be consolidated to the rooms that have returned a positive occupancy status and the rooms that have returned a negative occupancy status could be ignored or checked later. Substantial time and manpower could be utilized, effectively saving more lives.

The communication device 5 could also function as an application to a smart phone or tablet. Similarly, the communication device 5 would access the storage database 6 to retrieve occupancy information of a room. Fore example, a building with one hundred rooms would display a graphic with one hundred squares with each room identified. Squares would be displayed in a particular color for positive occupancy status or negative occupancy status. Also, a number could be associated with a square if multiple occupants are with a single room. The communication device 5 could also be mounted outside of the room so that a housekeeper or managing attendant could obtain the occupancy information directly from the location of the room. This would eliminate the nuisance of knocking on guest doors to determine room occupancy.

The present invention should also store any data attained by the thermal imaging system 7 and the motion detection system 8. This should be performed by formatting the data into storable information. For example, a motion detection signal should be formatted appropriately to be stored as motion detection information; concurrently, a thermal image should be formatted appropriately to be stored as thermal detection information. This provides a log of the detections within the room.

Although the invention has been explained in relation to its preferred embodiment, it is to be understood that many other possible modification and variations can be made without departing from the spirit and scope of the invention as hereinafter claimed.

What is claimed is:

1. A method of creating a room occupancy detection system by executing computer-executable instructions stored on a non-transitory computer-readable medium, the method comprises the steps of:
providing a thermal imaging system, wherein the thermal imaging system includes a plurality of thermal detection cameras;
providing a motion detection system, wherein the motion detection system includes a door motion sensor and a plurality of room motion sensors;
providing a control system that includes a signal processing software and a thermal detection criteria;
providing a communication device, wherein the communication device includes a graphic user interface;
providing a storage database;
determining an occupant thermal signature within an occupancy area through the thermal imaging system and the control system;
receiving a door-closed signal from the door motion sensor, wherein the door-closed signal indicates that the occupancy area is closed;
determining occupant movement within the occupancy area through the motion detection system;
determining a positive occupancy status or a negative occupancy status using the thermal imaging system, the motion detection system, and the signal processing software;
computing an occupancy number from the thermal imaging system;
storing thermal detection information, motion detection information, positive occupancy information and negative occupancy information within the storage database; and
displaying an occupancy status and the occupancy number on the graphic user interface.

2. The method of creating a room occupancy system by executing computer-executable instructions stored on a non-transitory computer-readable medium, the method as claimed in claim 1 comprises the steps of:
scanning the occupancy area with the plurality of thermal detection cameras;
receiving a thermal image from each of the plurality of thermal detection cameras; and
matching the thermal image with the thermal detection criteria in order to find the occupant thermal signature.

3. The method of creating a room occupancy system by executing computer-executable instructions stored on a non-transitory computer-readable medium, the method as claimed in claim 1 comprises the steps of:
receiving a motion detection signal from the plurality of room motion sensors, if the plurality of room motion sensors is triggered by movement within the occupancy area; and
recognizing the motion detection signal as the occupant movement.

4. The method of creating a room occupancy system by executing computer-executable instructions stored on a non-transitory computer-readable medium, the method as claimed in claim 1 comprises the steps of:
receiving the door-closed signal from the door motion sensor;
detecting occupant movement from the plurality of room motion sensors;
analyzing the door-closed signal and the occupant movement in order to determine if the occupant movement occurs after the door-closed signal is received; and
returning the positive occupancy status if the occupant movement occurs after the door-closed signal is received.

5. The method of creating a room occupancy system by executing computer-executable instructions stored on a non-transitory computer-readable medium, the method as claimed in claim 4 comprises the steps of:
formatting the door-closed signal and the occupant movement into motion detection information;
formatting the positive occupancy status into positive occupancy information; and
saving the positive occupancy information and the motion detection information within the storage database, wherein the positive occupancy information and the motion detection information can be retrieved by the communication device.

6. The method of creating a room occupancy system by executing computer-executable instructions stored on a non-transitory computer-readable medium, the method as claimed in claim 1 comprises the steps of:
receiving a door-closed signal from the door motion sensor;
detecting the occupant thermal signature from the thermal imaging system;
analyzing the door-closed signal and the occupant thermal signature in order to determine if the occupant thermal signature is detected after the door-closed signal is received; and
returning the positive occupancy status if the occupant thermal signature is detected after the door-closed signal is received.

7. The method of creating a room occupancy system by executing computer-executable instructions stored on a non-transitory computer-readable medium, the method as claimed in claim 6 comprises the steps of:
formatting the door-closed signal and the occupant's movement into motion detection information;
formatting the occupant thermal signature into the thermal detection information;
formatting the positive occupancy status into positive occupancy information; and
saving the positive occupancy information, the motion detection information, and the thermal detection information within the storage database, wherein the positive occupancy information, the motion detection information, and the thermal detection information can be retrieved by the communication device.

8. The method of creating a room occupancy system by executing computer-executable instructions stored on a non-transitory computer-readable medium, the method as claimed in claim 1 comprises the steps of:
receiving the door-closed signal from the door motion sensor;
detecting the occupant thermal signature from the thermal imaging system;
analyzing the door-closed signal and the occupant thermal signature in order to determine if the occupant movement signal is detected after the door-closed signal is received; and
returning a negative occupancy if the occupant thermal signature is detected before the door-closed signal is received.

9. The method of creating a room occupancy system by executing computer-executable instructions stored on a non-transitory computer-readable medium, the method as claimed in claim 8 comprises the steps of:
formatting the door-closed signal and the occupant movement into motion detection information;
formatting the occupant thermal signature into thermal detection information;
formatting the negative occupancy status into positive occupancy information; and
saving the negative occupancy information, the motion detection information, and the thermal detection information within the storage database, wherein the negative occupancy information, the motion detection information, and the thermal detection information can be retrieved by the communication device.

10. The method of creating a room occupancy system by executing computer-executable instructions stored on a non-transitory computer-readable medium, the method as claimed in claim 1 comprises the steps of:
analyzing a video feed from each of the plurality of thermal detection cameras in order to find a plurality of occupant thermal signatures;
assigning an incrementing number to each of the plurality of occupant thermal signatures; and
computing the occupancy number by finding the incrementing number with the greatest magnitude.

11. The method of creating a room occupancy system by executing computer-executable instructions stored on a non-transitory computer-readable medium, the method as claimed in claim 10 comprises the steps of:
formatting the occupancy number into occupancy number information; and
saving the occupancy number information within the storage database, wherein the occupancy number information can be retrieved by the communication device.

12. The method of creating a room occupancy system by executing computer-executable instructions stored on a non-transitory computer-readable medium, the method as claimed in claim 10 comprises the steps of:
relaying a plurality of video feeds from the plurality of thermal detection cameras to the storage database; and
saving the plurality of video feeds within the storage database.

13. The method of creating a room occupancy system by executing computer-executable instructions stored on a non-transitory computer-readable medium, the method as claimed in claim 1 comprises the steps of:
searching the storage database in order to determine the occupancy status, wherein the occupancy status is recognized as the positive occupancy status or the negative occupancy status;
searching the storage database in order to find the occupancy number information; and
displaying the occupancy status and the occupancy number on the graphic user interface.

14. A room occupancy detection system comprises:
a thermal imaging system;
a motion detection system;
a control system;
an communication device;
the thermal imaging system comprises a plurality of thermal detection cameras;
the motion detection system comprises a door motion sensor, and a plurality of room motion sensors; and
the thermal imaging system and the motion detection system being positioned within a room, wherein the room comprises a floor, a ceiling, an occupancy area, a plurality of inner walls, and a door.

15. The room occupancy detection system as claimed in claim 14 comprises,
the plurality of inner walls comprises an entrance wall;
the entrance wall being traversed by an entrance opening;
the door being positioned within the entrance opening, wherein the door is able to open and close; and
the occupancy area being delineated by the plurality of inner walls, the entrance wall, the floor, and the ceiling.

16. The room occupancy detection system as claimed in claim 14 comprises,
the plurality of thermal detection cameras being located within the occupancy area;
the door motion sensor being located near the door and the entrance opening; and
the plurality of room motion sensors being located within the occupancy area.

17. The room occupancy detection system as claimed in claim 14 comprises,
the communication device, the thermal imaging system and the motion detection system each being communicatively coupled with the control system through a network connection.
